(19) United States
(12) Patent Application Publication
(10) Pub. No.: US 2026/0056764 A1
(43) Pub. Date: Feb. 26, 2026

(54) EFFICIENT MEMORY MAPPING FOR PCI DEVICES ASSOCIATED WITH A VIRTUAL MACHINE

(71) Applicant: RED HAT, INC., Raleigh, NC (US)

(72) Inventor: Michael Tsirkin, Yokneam (IL)

(21) Appl. No.: 18/811,247

(22) Filed: Aug. 21, 2024

(51) Int. Cl. G06F 9/455

(52) U.S. Cl. CPC G06F 9/45558; G06F 2009/45579; G06F 2009/45583

(57) ABSTRACT

In one example, a virtual machine can establish a virtual Peripheral Component Interconnect (vPCI) system. The vPCI system can include a virtual gate bridge and vPCI devices. The virtual gate bridge can be disabled. While the virtual gate bridge is disabled, the virtual machine can enable the vPCI devices. After enabling the vPCI devices, the virtual machine can transmit a request to enable the virtual gate bridge. A hypervisor associated with the virtual machine can detect the request and, in response to detecting the request, generate a memory mapping. In the memory mapping, memory regions associated with the vPCI devices can be correlated to memory addresses in an address space of the virtual machine. The memory mapping can be used to allow the virtual machine to interact with the vPCI devices.

### TECHNICAL FIELD

The present disclosure relates generally to virtual machines. More specifically, but not by way of limitation, this disclosure relates to efficient memory mapping for Peripheral Component Interconnect (PCI) devices associated with a virtual machine.

### BACKGROUND

A virtual machine is a software emulation of a physical computer that can have its own operating system, software applications, and virtualized hardware. For example, a virtual machine can have a virtual Central Processing Unit (vCPU), a virtual Random Access Memory (vRAM), and other components. In some cases, a virtual machine can have a virtual Peripheral Component Interconnect (vPCI) system for attaching virtual hardware devices to the virtual machine. Virtual machines provide isolation that can allow multiple operating systems to be run on a single physical machine, enhancing resource utilization and flexibility.

Virtual machines can be deployed on a physical machine using a hypervisor. A hypervisor is a software layer that is conceptually positioned above a physical layer (e.g., the hardware) of the physical machine and below the virtual machine, such that the hypervisor serves as an interface between the physical layer and the virtual machine. A hypervisor can allow multiple virtual machines to run concurrently on a single physical machine by abstracting and managing the underlying hardware resources of the physical machine.

### BRIEF DESCRIPTION OF THE DRAWINGS

FIG. 1 is a block diagram of an example of a system for providing efficient memory mapping for PCI devices associated with a virtual machine, according to some aspects of the present disclosure.

FIG. 2 is a block diagram of an example of a system for providing efficient memory mapping for PCI devices associated with a virtual machine, according to some aspects of the present disclosure.

FIG. 3 is a flowchart of an example of a process for providing efficient memory mapping for PCI devices associated with a virtual machine, according to some aspects of the present disclosure.

### DETAILED DESCRIPTION

A hypervisor can be used to deploy a virtual machine (VM) on a computing device. In some cases, it may be desirable to allow the VM to access a PCI device, such as a physical PCI device or a vPCI device. To allow the VM to access the PCI device, two steps are normally performed during the boot-up process of the VM. First, the VM enables the PCI device. This may involve enabling memory access to the PCI device by setting its Memory Space Enable (MSE) bit. Second, the hypervisor updates a memory mapping to correlate memory regions of the PCI device to an address space of the VM. While this process can be acceptably fast for a single PCI device, problems can arise when there are multiple PCI devices. The reason is that this process must be repeated one-by-one for each individual PCI device during the boot-up process. Thus, if there are N PCI devices, the process is repeated N times. With each iteration, the hypervisor updates (e.g., modifies or replaces) the memory mapping to incorporate the new mapping data for the corresponding PCI device, which introduces overhead and latency. The compounding effect of such updates over multiple iterations is a VM boot-up time that can be on the order of minutes, which is unacceptably long in many scenarios.

Some examples of the present disclosure can overcome one or more of the abovementioned problems by introducing a virtual PCI bridge, referred to herein as a “virtual gate bridge,” to the boot-up process for a VM. More specifically, the VM can include a vPCI system to which the virtual gate bridge can be added. vPCI devices can then be placed behind the virtual gate bridge in the vPCI system. The vPCI devices may or may not correspond to physical PCI devices connected to the computing device. During the VM's boot-up process, the virtual gate bridge can be initialized to a disabled state. While the virtual gate bridge is disabled, the VM can scan the vPCI devices and enable them one-by-one, for example by setting their MSE bits. Once all the vPCI devices are enabled, the VM can enable the virtual gate bridge. This may involve transmitting a request to enable the virtual gate bridge. The request can serve as a notification that triggers the hypervisor to generate the memory mapping. The hypervisor can detect the request and responsively generate a single memory mapping which covers all the enabled vPCI devices. Thus, the hypervisor only generates the memory mapping a single time, after all the vPCI devices are enabled, rather than iteratively updating the memory mapping as each vPCI device is enabled one-by-one. By eliminating such iterative updates to the memory mapping, overhead and latency can be significantly reduced. In some cases, this can speed up the boot-up process for the VM from minutes to seconds.

In some examples, the virtual gate bridge can be enabled by setting one or more of its registers to specify the memory range associated with the vPCI devices located behind the virtual gate bridge. For example, the VM can set a Base Address Register (“BAR” or “Base Register”) for the virtual gate bridge to a starting address of the memory range. The VM can also set a Limit Register for the virtual gate bridge to an ending address of the memory range. By setting the Base/Limit registers to the starting and ending addresses, respectively, the VM can define the memory region that the virtual gate bridge can allocate to those vPCI devices. Additionally, or alternatively, the virtual gate bridge can be enabled by setting its MSE bit. The MSE bit can be located in a Command Register of the virtual gate bridge. A Command Register is a register in the PCI configuration space of a PCI device. The Command Register can include several control bits that determine the behavior of the PCI device. One of those control bits can be the MSE bit, which can be set (e.g., changed from ‘0 ’ to ‘1’) to allow the PCI device to respond to memory space accesses.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

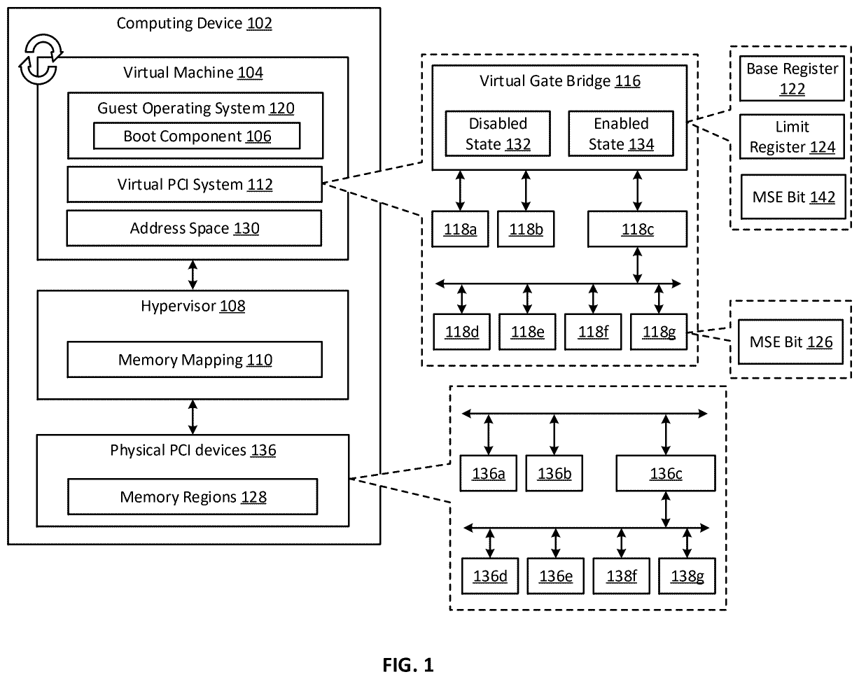

FIG. 1 is a block diagram of an example of a system for providing efficient memory mapping for PCI devices associated with a virtual machine, according to some aspects of the present disclosure. The system includes a computing device 102, such as a laptop computer, desktop computer, server, or mobile phone.

The computing device 102 can include a hypervisor 108. The computing device 102 can execute the hypervisor 108 to deploy a virtual machine 104. Before the virtual machine 104 is ready for use, it can undergo a boot-up process, which is represented in FIG. 1 by the semi-circular arrows. A boot component 106 can perform the boot-up process. The boot component 106 can be included in a guest operating system 120 of the virtual machine 104 or in boot firmware of the virtual machine 104. In some examples, the hypervisor 108 can provide the boot component 106 to the virtual machine 104 for use during the boot-up process.

As part of the boot-up process, the boot component 106 can establish a vPCI system 112 with a virtual gate bridge 116. The boot component 106 can initialize the virtual gate bridge 116 to a disabled state 132. Any number of vPCI devices can then be positioned behind the virtual gate bridge 116 in the vPCI system 112. Examples of such vPCI devices can include a network card, a graphics card, a sound card, and/or a vPCI bridge.

In the example shown in FIG. 1, the vPCI system 112 has seven vPCI devices 118a-g positioned behind the virtual gate bridge 116. Those vPCI devices 118a-g are positioned lower in a hierarchy than the virtual gate bridge 116. In some examples, the vPCI system 112 can have multiple levels in the hierarchy. For instance, the virtual gate bridge 116 can be coupled to vPCI devices 118a-c. The vPCI devices 118a-c can be considered at the same level in the hierarchy. The vPCI device 118c can be a vPCI bridge that is also coupled to vPCI devices 118d-g, which can be considered lower in the hierarchy than the vPCI device 118c. Thus, in the example shown in FIG. 1, the virtual gate bridge 116 can be higher in the hierarchy than vPCI device 118a-c, and vPCI devices 118a-c can be higher in the hierarchy than the vPCI devices 118d-g.

In other examples, the virtual gate bridge 116 can be positioned elsewhere in the vPCI system 112. For instance, if the virtual gate bridge 116 is primarily serving as a triggering mechanism for the virtual machine 104 to signal the hypervisor 108 to generate a memory mapping 110, then its exact position in the vPCI system 112 may not be important, so it can be positioned elsewhere in the hierarchy. On the other hand, if the virtual gate bridge 116 is serving the dual purpose of operating as a bridge for vPCI devices and serving as the triggering mechanism, then its exact position in the vPCI system 112 may be more important.

Some or all of the vPCI devices 118a-g can correspond to physical PCI devices 136a-g, which can be connected to the computing device 102. For example, vPCI device 118a can correspond to physical PCI device 136a, vPCI device 118b can correspond to physical PCI device 136b, vPCI device 118c can correspond to physical PCI device 136c, etc. In this way, the vPCI devices 118a-g can serve as virtual representations of the physical PCI devices 136a-g. Additionally or alternatively, some or all of the vPCI devices 118a-g may emulate physical PCI devices that are not actually connected to the computing device 102.

After the vPCI system 112 has been established, and while the virtual gate bridge 116 is disabled, the boot component 106 can enable the vPCI devices 118a-g. For example, the boot component 106 may sequentially enable the vPCI devices 118a-g one-by-one. To do so, the boot component 106 can set an MSE bit located in a Command Register of each of the vPCI devices 118a-g. For example, to enable the vPCI device 118g, the virtual machine can set the MSE bit 126 of the vPCI device 118g. Setting the MSE bit 126 may involve changing its value from ‘0 ’ to ‘1’. If the vPCI device is a virtual bridge (e.g., as with vPCI device 118c), then enabling the vPCI device may also include setting its Base/Limit Registers to specify a memory range associated with the vPCI devices 118d-g located behind the virtual bridge.

Once the vPCI devices 118a-g are all enabled, the boot component 106 can enable the virtual gate bridge 116, thereby transitioning the virtual gate bridge 116 from the disabled state 132 to an enabled state 134. The boot component 106 may only enable the virtual gate bridge 116 after all the other vPCI devices 118a-g are enabled. To enable the virtual gate bridge 116, the boot component 106 may transmit a request to set one or more of the virtual gate bridge's registers to a memory range associated with the vPCI devices 118a-g. For example, the boot component 106 can set a BAR 122 for the virtual gate bridge 116 to a starting address of the memory range. The boot component 106 can also set a Limit Register 124 for the virtual gate bridge 116 to an ending address of the memory range. By setting the Base/Limit registers 122, 124 to the starting and ending addresses, respectively, the boot component 106 can define the memory region that the virtual gate bridge 116 can allocate to those vPCI devices 118a-g. Additionally or alternatively, to enable the virtual gate bridge 116, the boot component 106 can transmit a request to set an MSE bit 142 of the virtual gate bridge 116.

The process of enabling the virtual gate bridge 116 may serve as a triggering event, which causes the hypervisor 108 to generate a memory mapping 110. For example, the hypervisor 108 can detect one or more of the requests from the boot component 106 for enabling the virtual gate bridge 116. In response to detecting the one or more requests, the hypervisor 108 can generate the memory mapping 110. Thus, the hypervisor 108 may not generate the memory mapping 110 until after it detects the one or more requests. In this way, the one or more requests can serve as a notification to the hypervisor 108 of when to generate the memory mapping 110. The hypervisor 108 can then generate the memory mapping 110 in a single pass.

The memory mapping 110 can include correlations between memory regions 128 associated with the PCI devices (e.g., vPCI devices 118a-g and/or physical PCI devices 136a-g) and memory addresses in the address space 130 of the virtual machine 104. For example, the memory mapping 110 can include a first correlation between a first memory region assigned to vPCI device 118a and a first memory address assigned to the virtual machine 104. The memory mapping 110 can also include a second correlation between a second memory region assigned to vPCI device 118b and a second memory address assigned to the virtual machine 104. If there are N PCI devices that are enabled by the boot component 106, then the memory mapping 110 may include N such correlations. The memory mapping 110 can be generated a single time during the boot-up process for all of the enabled PCI devices and remain unchanged for a remainder of the boot-up process. In other words, the memory mapping 110 may not be updated or replaced during a remainder of the boot-up process after its initial creation.

Through the above process, the boot component 106 can enable all desired vPCI devices 118a-g and then signal the hypervisor 108 to generate a memory mapping 110 by enabling the virtual gate bridge 116. The hypervisor 108 can then generate the memory mapping 110 a single time for all of the enabled vPCI devices 118a-g. This eliminates the need for iteratively updating the memory mapping 110, thereby significantly reducing overhead and latency during the boot-up process.

It will be appreciated that, in other examples, the boot component 106 may notify the hypervisor 108 to generate the memory mapping 110 in other ways than enabling a virtual gate bridge 116. For example, the boot component 106 may notify the hypervisor 108 through a message or by enabling another type of vPCI device 118a. But some of these other approaches may require more adjustments to existing hypervisor/VM frameworks than using the virtual gate bridge 116 as the triggering mechanism, making them more cumbersome to implement.

In some examples, the boot component 106 may not enable all of the vPCI devices 108a-g that are available in the vPCI system 112. For instance, the virtual machine 104 may only want to access a subset of the available vPCI devices 118a-g, such as vPCI devices 108a, 108e, and 108f. So, the boot component 106 may only enable that subset of vPCI devices, and none of the other vPCI devices, using the techniques described above. One that is complete, the boot component 106 can enable the virtual gate bridge 116. This can trigger the hypervisor 108 to generate the memory mapping 110, which may only include correlations for the enabled subset of vPCI devices and none of the other disabled vPCI devices. In this way, the above process can be selectively applied to a subset of the available vPCI devices 108a-g in the vPCI system 112.

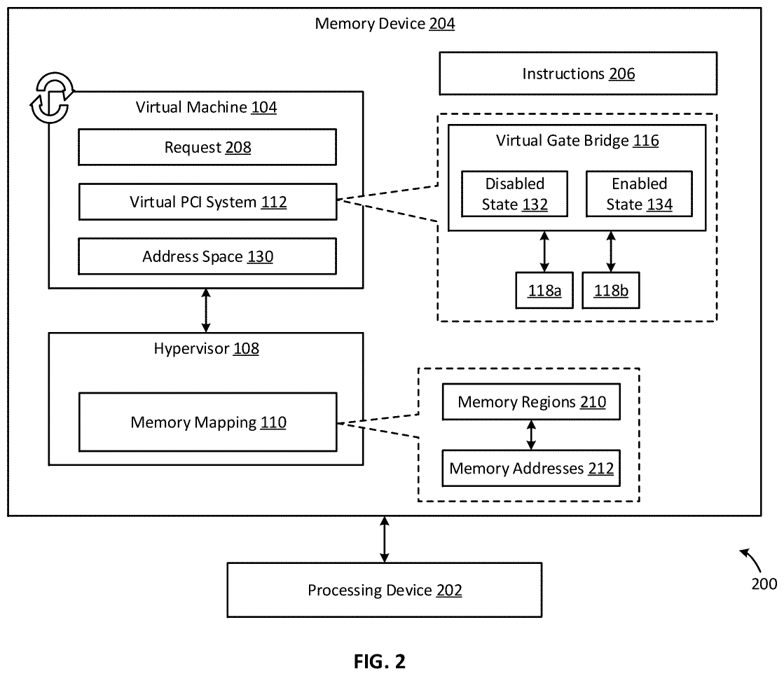

Turning now to FIG. 2, shown is a block diagram of an example of a system 200 for providing efficient memory mapping for PCI devices 118a-b associated with a virtual machine 104, according to some aspects of the present disclosure. In some examples, the system 200 may be implement on a computing device, such as the computing device 102 of FIG. 1.

The system 200 can include a processor 202 communicatively coupled to a memory 204 by a bus. The processor 202 can include one processing device or multiple processing devices. Non-limiting examples of the processor 202 include a Field-Programmable Gate Array (FPGA), an application-specific integrated circuit (ASIC), a microprocessor, or any combination of these. The processor 202 can execute instructions 206 stored in the memory 204 to perform operations, such as any of the operations described herein with respect to the virtual machine 104 and/or hypervisor 108. In some examples, the instructions 206 can include processor-specific instructions generated by a compiler or an interpreter from code written in any suitable computer-programming language, such as C, C++, C #, Python, or Java.

The memory 204 can include one memory device or multiple memory devices. The memory 204 can be volatile or non-volatile, such that the memory 204 retains stored information when powered off. Non-limiting examples of the memory 204 include electrically erasable and programmable read-only memory (EEPROM), flash memory, or any other type of non-volatile memory. At least some of the memory device can include a non-transitory computer-readable medium from which the processor 202 can read the instructions 206. A computer-readable medium can include electronic, optical, magnetic, or other storage devices capable of providing the processor 202 with computer-readable instructions or other program code. Non-limiting examples of a computer-readable medium can include magnetic disks, memory chips, ROM, random-access memory (RAM), an ASIC, a configured processor, optical storage, or any other medium from which a computer processor can read the instructions 206.

In some examples, the processor 202 can execute the instructions 206 to perform operations. For example, a virtual machine 104 executing on the processor 202 can establish a vPCI system 112 for the virtual machine 104. The vPCI system 112 can include a virtual gate bridge 116 and vPCI devices 118a-b. The virtual gate bridge 116 can be disabled (e.g., in a disabled state 132). While the virtual gate bridge 116 is disabled, the virtual machine 104 can enable the vPCI devices 118a-b. For example, the virtual machine 104 can enable the vPCI devices 118a-b one-by-one. After enabling the vPCI devices 118a-b, the virtual machine 104 can transmit a request 208 to enable the virtual gate bridge 116. A hypervisor 108 that is associated with the virtual machine 104 can detect the request 208. In response to detecting the request 208, the hypervisor 108 can generate a memory mapping 110 in which memory regions 210 (e.g., memory-mapped I/O (MMIO) regions) associated with the vPCI devices 118a-b are correlated to memory addresses 212 in an address space 130 of the virtual machine 104.

The memory mapping 110 can be used by the hypervisor 108 to allow the virtual machine 104 to interact with the vPCI devices 118a-b. For example, when the virtual machine 104 transmits an input/output (I/O) request to a vPCI device 118a, the virtual machine 104 can include a memory address 212 in the I/O request. The memory address 212 can be a location that is associated with the vPCI device 118a in the address space 130 of the virtual machine 104. The hypervisor 108 can detect the I/O request and use the memory mapping 110 to translate the memory address 212 to a corresponding memory region 210. That memory region 210 can then be used to complete the I/O request.

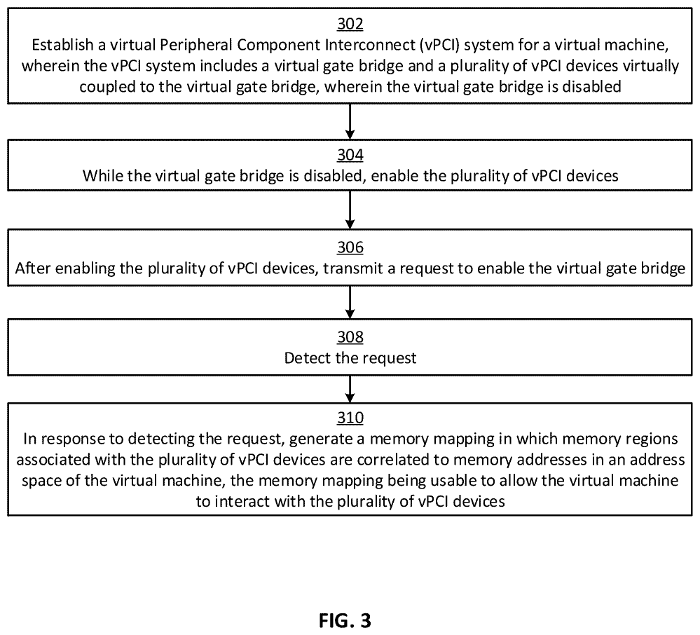

Turning now to FIG. 3, shown is a flowchart of an example of a process for providing efficient memory mapping for PCI devices associated with a virtual machine, according to some aspects of the present disclosure. Other examples may involve more operations, fewer operations, different operations, or a different sequence of operations than is shown in FIG. 3. The operations of FIG. 3 are described below with reference to the components of FIG. 2 described above.

In some examples, blocks 302-306 can be implemented by a virtual machine 104. For instance, blocks 302-306 may be implemented by a boot component of the virtual machine 104. The boot component may be part of a guest operating system of the virtual machine 104 or boot firmware of the virtual machine 104. Additionally, a hypervisor 108 can implement blocks 308-310. The hypervisor 108 may be used to deploy the virtual machine 104 and, in some examples, may provide the boot component to the virtual machine 104. Because the virtual machine 104 and/or the hypervisor 108 can be executed by a processor 202, it can be said that the processor 202 implements some or all of blocks 302-310. Each of those blocks will now be described in turn.

In block 302, the virtual machine 104 establishes a virtual Peripheral Component Interconnect (vPCI) system 112 for the virtual machine 104. The vPCI system 112 can include a virtual gate bridge 116 and vPCI devices 118a-b. The virtual gate bridge 116 can be disabled. If the virtual gate bridge 116 is not already disabled by default, the virtual machine 104 can disable the virtual gate bridge 116 at this stage. Disabling the virtual gate bridge 116 may involve resetting a MSE bit (e.g., changing it from a ‘1’ to a ‘0’) of the virtual gate bridge 116. Disabling the virtual gate bridge 116 may additionally or alternatively involve resetting a BAR and/or a Limit Register of the virtual gate bridge 116, for example by clearing their values.

In block 304, while the virtual gate bridge 116 is disabled, the virtual machine 104 enables the vPCI devices 118a-b. For example, the virtual machine 104 can scan the vPCI system 112 to identify the vPCI devices 118a-b and then sequentially enable the vPCI devices 118a-b one-by-one. Enabling a vPCI device 118 can involve setting a MSE bit of the vPCI device 118.

In block 306, after enabling the vPCI devices 118a-b, the virtual machine 104 transmits a request 208 to enable the virtual gate bridge 116. For example, the virtual machine 104 can transmit the request 208 to the vPCI system 112. The request 208 can include an instruction to set a MSE bit of the virtual gate bridge 116. Additionally, or alternatively, the request 208 can include an instruction to set the BAR and/or the Limit Register of the virtual gate bridge 116 to define a memory range, which can be assigned to the vPCI devices 118a-b.

In block 308, a hypervisor 108 that is associated with the virtual machine 104 detects the request 208. The hypervisor 108 can be used to deploy and manage the virtual machine 104. Because the hypervisor 108 can access to everything the virtual machine 104 can access and more, the hypervisor 108 can detect that the request 208 has been sent by the virtual machine 104.

In block 310, in response to detecting the request 208, the hypervisor 108 generates a memory mapping 110. In the memory mapping 110, memory regions 210 are correlated to memory addresses 212. The memory regions 210 and memory addresses 212 can both be associated with the vPCI devices 118a-b. The memory addresses 212 can be located in an address space 130 of the virtual machine 104. The memory mapping 110 can be used by the hypervisor 108 to allow the virtual machine 104 to interact with the vPCI devices 118a-b. For example, the memory mapping 110 can be used to allow the virtual machine 104 to transmit I/O requests to the vPCI devices 118a-b.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, any examples described herein can be combined with any other examples to yield further examples.

1. A system comprising:
one or more processors; and
one or more memories storing instructions that are executable by the one or more processors for causing a virtual machine to perform operations including:
establishing a virtual Peripheral Component Interconnect (vPCI) system for the virtual machine, wherein the vPCI system includes a virtual gate bridge and vPCI devices, and wherein the virtual gate bridge is disabled;
while the virtual gate bridge is disabled, enabling the vPCI devices; and
after enabling the vPCI devices, transmitting a request to enable the virtual gate bridge, wherein a hypervisor that is associated with the virtual machine is configured to:
detect the request; and
in response to detecting the request, generate a memory mapping in which memory regions associated with the vPCI devices are correlated to memory addresses in an address space of the virtual machine, the memory mapping being usable to allow the virtual machine to interact with the vPCI devices.

2. The system of claim 1, wherein the operation of enabling the vPCI devices involves:
setting Memory Space Enable (MSE) bits associated with the vPCI devices to an enabled state.

3. The system of claim 1, wherein the operation of enabling the virtual gate bridge involves:
setting a Base Address Register of the virtual gate bridge to a starting address of a memory region associated with the vPCI devices; and
setting a Limit Register of the virtual gate bridge to an ending address of the memory region.

4. The system of claim 1, wherein the operation of enabling the virtual gate bridge involves:
setting an MSE bit associated with the virtual gate bridge to an enabled state.

5. The system of claim 1, wherein the vPCI devices include a vPCI bridge that is different from the virtual gate bridge, and wherein enabling the vPCI bridge involves setting a Base Address Register and a Limit Register of the vPCI bridge.

6. The system of claim 1, wherein the operations are performed during a boot-up process for the virtual machine.

7. The system of claim 6, wherein after the memory mapping is generated, the memory mapping is not updated again during a remainder of the boot-up process for the virtual machine.

8. The system of claim 1, wherein the operations are performed by a boot component of the virtual machine, wherein the boot component is included in boot firmware or a guest operating system of the virtual machine.

9. A computer-implemented method comprising:
establishing, by a virtual machine, a virtual Peripheral Component Interconnect (vPCI) system for the virtual machine, wherein the vPCI system includes a virtual gate bridge and vPCI devices, and wherein the virtual gate bridge is disabled;
while the virtual gate bridge is disabled, enabling, by the virtual machine, the vPCI devices; and
after enabling the vPCI devices, transmitting, by the virtual machine, a request to enable the virtual gate bridge;
wherein a hypervisor that is associated with the virtual machine detects the request and responsively generates a memory mapping in which memory regions associated with the vPCI devices are correlated to memory addresses in an address space of the virtual machine, the memory mapping being usable to allow the virtual machine to interact with the vPCI devices.

10. The method of claim 9, wherein the operation of enabling the vPCI devices involves:
setting Memory Space Enable (MSE) bits associated with the vPCI devices to an enabled state.

11. The method of claim 9, wherein enabling the virtual gate bridge involves:
setting a Base Address Register of the virtual gate bridge to a starting address of a memory region associated with the vPCI devices; and
setting a Limit Register of the virtual gate bridge to an ending address of the memory region.

12. The method of claim 9, wherein enabling the virtual gate bridge involves:
setting an MSE bit associated with the virtual gate bridge to an enabled state.

13. The method of claim 9, wherein the vPCI devices include a vPCI bridge that is different from the virtual gate bridge.

14. The method of claim 9, wherein the method is performed during a boot-up process for the virtual machine.

15. The method of claim 14, wherein after the memory mapping is generated, the memory mapping is not updated again during a remainder of the boot-up process for the virtual machine.

16. The method of claim 9, wherein the method is performed by a boot component of the virtual machine, wherein the boot component is included in boot firmware or a guest operating system of the virtual machine.

17. A non-transitory computer-readable medium comprising program code that is executable by one or more processors for causing a virtual machine to perform operations including:
establishing a virtual Peripheral Component Interconnect (vPCI) system for the virtual machine, wherein the vPCI system includes a virtual gate bridge and vPCI devices, and wherein the virtual gate bridge is disabled;
while the virtual gate bridge is disabled, enabling the vPCI devices; and
after enabling the vPCI devices, transmitting a request to enable the virtual gate bridge, wherein a hypervisor that is associated with the virtual machine is configured to:
detect the request; and
in response to detecting the request, generate a memory mapping in which memory regions associated with the vPCI devices are correlated to memory addresses in an address space of the virtual machine, the memory mapping being usable to allow the virtual machine to interact with the vPCI devices.

18. The non-transitory computer-readable medium of claim 17, wherein the operations are performed during a boot-up process for the virtual machine.

19. The non-transitory computer-readable medium of claim 18, wherein after the memory mapping is generated, the memory mapping is not updated again during a remainder of the boot-up process for the virtual machine.

20. The non-transitory computer-readable medium of claim 17, wherein the operations are performed by a boot component of the virtual machine, wherein the boot component is included in boot firmware or a guest operating system of the virtual machine.
